(19) United States
(12) Patent Application Publication
(10) Pub. No.: US 2021/0081820 A1
(43) Pub. Date: Mar. 18, 2021

(54) AREA TRANSITION PREDICTION DEVICE AND AREA TRANSITION PREDICTION METHOD

(71) Applicant: TOSHIBA TEC KABUSHIKI KAISHA, Tokyo (JP)

(72) Inventor: Katsuhito MOCHIZUKI, Tagata Shizuoka (JP)

(73) Assignee: TOSHIBA TEC KABUSHIKI KAISHA, Tokyo (JP)

(21) Appl. No.: 16/905,771

(22) Filed: Jun. 18, 2020

(30) Foreign Application Priority Data
Sep. 13, 2019 (JP) 2019-167190

(51) Int. Cl. G06N 5/04; G06F 16/587; G06Q 30/02

(52) U.S. Cl. CPC G06N 5/04; G06Q 30/0201; G06F 16/587

(57) ABSTRACT

An area transition prediction device includes at least one processor having an acquisition unit, and an information processing unit, and an output unit. The at least one processor acquires behavior history information, the behavior history information including positional information of a user and date information corresponding to the positional information. The at least one processor predicts transition from a current position to a first area of the user based on the behavior history information and map information, the map information including a plurality of areas. The output unit outputs information based on the prediction of the transition.

### CROSS-REFERENCE TO RELATED APPLICATION

This application is based upon and claims the benefit of priority from Japanese Patent Application No. 2019-167190, filed in Sep. 13, 2019, the entire contents of which are incorporated herein by reference.

### FIELD

Embodiments described herein relate generally to an area transition prediction device and an area transition prediction method.

### BACKGROUND

In many stores such as supermarkets or convenience stores, commodity sales data processing systems are introduced. Such commodity sales data processing systems have a function of issuing discount coupons or the like of commodities and a sales promotion effect of the commodities by the function is expected. A method of paying attention to traffic lines of users in a store, posting commodity advertisements or the like along the traffic lines, and aiming at sales promotion is also well known.

### DESCRIPTION OF THE DRAWINGS

FIG. 1 is a diagram illustrating an example of an overall configuration of a transaction processing system according to at least one embodiment;

FIG. 2 is a schematic diagram illustrating an example of a layout of a store in which the transaction processing system is introduced;

FIG. 3 is a block diagram illustrating an example of a circuit configuration of main units of an information terminal;

FIG. 4 is a block diagram illustrating an example of a circuit configuration of main units of a store server;

FIG. 5 is a perspective view illustrating an example of a cart in which the information terminal is provided;

FIG. 6 is a block diagram illustrating an example of a circuit configuration of main units of a virtual POS server;

FIG. 7 is a diagram illustrating an example of a layout of each sales area in a store;

FIG. 8 is a diagram illustrating an example of map information corresponding to the layout of FIG. 7;

FIG. 9 is a diagram illustrating an example of a traffic line of a customer superimposed on the layout of FIG. 7 or the map of FIG. 8;

FIG. 10 is a diagram illustrating an example of behavior analysis of a specific customer by a store server;

FIG. 11 is a diagram illustrating an example of a first stay area analysis database managed by the store server;

FIG. 12 is a diagram illustrating an example of an area management database registered in the store server;

FIG. 13 is a diagram illustrating an example of a second stay area analysis database managed by the store server;

FIG. 14 is a diagram illustrating an example of a transition probability of a stay area by the store server;

FIG. 15 is a flowchart illustrating an example of transition prediction and information output of the stay area by the store server;

FIG. 16 is a flowchart illustrating an example of a transition prediction process by the store server; and

FIG. 17 is a flowchart illustrating an example of an information outputting process by the store server.

### DETAILED DESCRIPTION

Technologies for predicting traffic lines from route information of users in a store or the like are known. However, since mere passages are included in the traffic lines, purposeful behaviors of the users may not be ascertained merely by predicting the traffic lines. From such a background, technologies for predicting purposeful behaviors of the users with higher precision are desired.

An exemplary embodiment provides an area transition prediction device and an area transition prediction method which are excellent in prediction precision of purposeful behaviors of users.

According to at least one embodiment, an area transition prediction device includes at least one processor having an acquisition unit, and an information processing unit, and an output unit. The at least one processor acquires behavior history information, the behavior history information including positional information of a user and date information corresponding to the positional information. The at least one processor predicts transition from a current position to a first area of the user based on the behavior history information and map information, the map information including a plurality of areas. The output unit outputs information based on the prediction of the transition.

Hereinafter, at least one embodiment will be described with reference to the drawings. In at least one embodiment, information output based on area transition and transition prediction of a stay area in a transaction processing system enabling a customer who is a user to perform from registration to settlement of a purchased commodity by herself or himself will be described. In at least one embodiment, a transaction processing system enabling a customer registering sales data of a purchased commodity by operating an information terminal attached to a shopping cart in a sales region to perform settlement using any one of an accounting machine handled by a person or an accounting machine handled by the customer herself or himself will be exemplified.

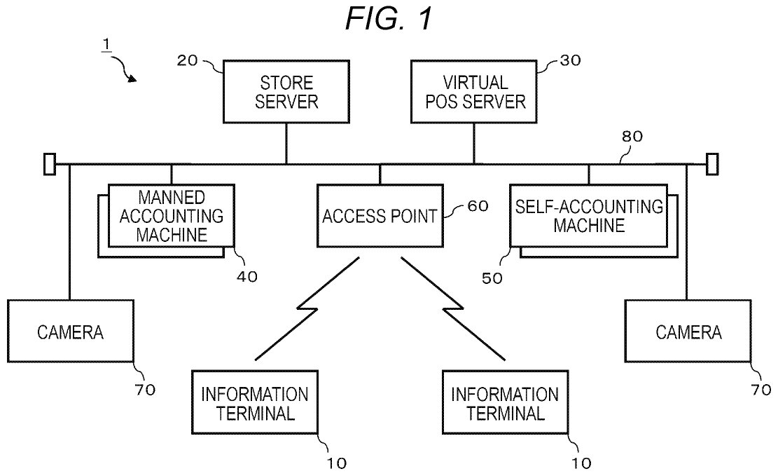

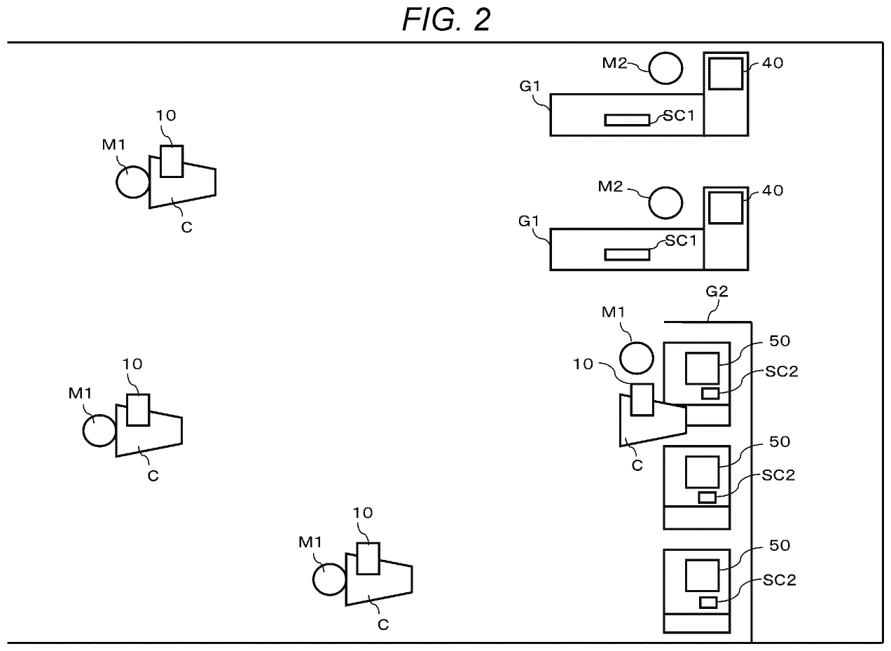

FIG. 1 is a diagram illustrating an example of an overall arrangement of a transaction processing system 1 according to at least one embodiment. FIG. 2 is a schematic diagram illustrating an example of a layout of a store in which the transaction processing system 1 is introduced. First, an overview of the transaction processing system 1 will be described with reference to FIGS. 1 and 2.

As illustrated in FIG. 1, the transaction processing system 1 includes an information terminal 10, a store server 20, a virtual point of sales (POS) server 30, a manned accounting machine 40, a self-accounting machine 50, an access point 60, a camera 70, and a network 80. The network 80 is, for example, a local area network (LAN). In the transaction processing system 1, the store server 20, the virtual POS server 30, the manned accounting machine 40, the self-accounting machine 50, the access point 60, and the camera 70 are connected to the network 80.

The information terminal 10 is a terminal that enables a customer who is a purchaser to input data related to registration of a purchased commodity by herself or himself. As illustrated in FIG. 2, the information terminal 10 is attached to a shopping cart C. Hereinafter, the shopping cart C is simply referred to as a cart C. The cart C is an example of a conveyer that conveys a purchased commodity of a customer M1 who is a user of the cart C. The information terminal 10 is preferably detachably attached to the cart C.

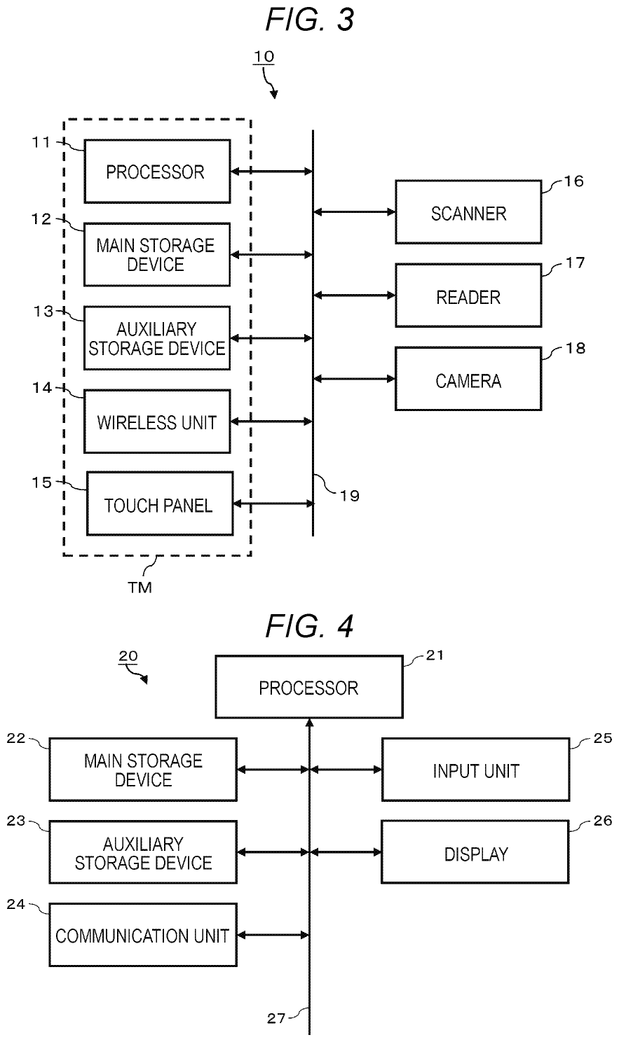

The information terminal 10 includes a wireless unit 14 (see FIG. 3) used to perform wireless communication with the access point 60. The access point 60 relays communication between the information terminal 10 and each device connected to the network 80. The single access point 60 or a plurality of access points 60 are disposed.

The store server 20 is a computer that supports entire store business, and is an area transition prediction device that acquires behavior history information or the like, predicts area transition, and outputs information based on the transition prediction. The store server 20 stores and manages various databases including a commodity database. The commodity database is a collective of commodity records in which data of commodities sold in a store is described. In the commodity records, commodity information such as commodity codes, prices, commodity names, exhibition area information, and recommended commodity information is described. The commodity code is an identification code set for each commodity to identify an individual commodity. A barcode or a 2-dimensional data code indicating a commodity code is normally attached to each commodity. The details of the store server 20 will be described later.

The virtual POS server 30 is a computer that cooperates with the information terminal 10 and performs support so that the information terminal 10 pretends to function as a POS terminal. The virtual POS server 30 is a kind of transaction processing device. The details of the information terminal 10 and the virtual POS server 30 will be described later.

The manned accounting machine 40 is a terminal with which a salesclerk performs settlement of at least a purchased commodity. That is, the manned accounting machine 40 is an example of an accounting machine handled by a person. A purchased commodity may be registered by the manned accounting machine 40. Therefore, a known POS terminal of the related art can be used as a manned accounting machine 40 without being changed.

The self-accounting machine 50 is a terminal with which a customer settles a purchased commodity by herself or himself. That is, the self-accounting machine 50 is an example of an accounting machine handled by the customer by herself or himself. A known semi-self-service-type accounting machine of the related art can be used as the self-accounting machine 50 without being changed. Alternatively, a self-type POS terminal can also be used as the self-accounting machine 50 without being changed.

The camera 70 is a camera used to perform imaging in a store. For example, a plurality of cameras 70 are connected to the network 80 and all the areas in the store are imaged by the plurality of cameras 70. The camera 70 transmits captured images to the store server 20 via the network 80.

As illustrated in FIG. 2, the manned accounting machine 40 is installed in an encounter register G1. In principle, a salesclerk M2 always stays at the encounter register G1. The customer M1 may not necessarily register a purchased commodity by herself or himself using the information terminal 10. A certain customer M1 entrusts registration of a purchased commodity to the salesclerk M2 at the encounter register G1. The manned accounting machine 40 basically corresponds to registration and accounting of the purchased commodity of such a customer M1.

At the encounter register G1, a scanner SC1 is provided. The scanner SC1 is connected to the manned accounting machine 40. The scanner SC1 may be of a stationary type or may be of a handheld type. The salesclerk M2 may scan a barcode attached to the purchased commodity of the customer M1 by using the scanner SC1. Through the scanning, the purchased commodity is registered in the manned accounting machine 40 and a settlement amount of one transaction is displayed on a display device of the manned accounting machine 40. Thus, the customer M1 pays the salesclerk M2 the money corresponding to the settlement amount. The money can be paid by a money coupon such as a gift certificate or a gift token as well as cash, a credit card, or electronic money. The salesclerk inputs data regarding the payment of the money to the manned accounting machine 40. Thus, a settlement process is performed in the manned accounting machine 40 and the purchased commodity is settled.

As illustrated in FIG. 2, the self-accounting machine 50 is installed at a self-register G2. No salesclerk stays at the self-register G2. The customer M1 who registers the purchased commodity by herself or himself using the information terminal 10 can go to the self-register G2 and settle the purchased commodity with the vacant self-accounting machine 50. That is, in the transaction processing system 1, a customer can perform from the registration to the settlement of a purchased commodity by herself or himself.

At the self-register G2, a scanner SC2 is provided. The scanner SC2 is connected to the self-accounting machine 50. The scanner SC2 may be of a stationary type or may be of a handheld type. The customer M1 scans an accounting barcode to be described later with the scanner SC2. Through the scanning, a purchased commodity list of the customer M1 is input to the self-accounting machine 50 and a settlement amount of one transaction is displayed. Thus, the customer M1 feeds cash corresponding to the settlement amount into a change machine equipped in the self-accounting machine 50. Alternatively, the customer M1 causes a reader of the self-accounting machine 50 to read data recorded in a settlement card such as a credit card or an electronic money card. Thus, a settlement process is performed in the self-accounting machine 50 and the purchased commodity is settled.

Incidentally, as a payment method, a money coupon such as a gift certificate or a gift token as well as cash, a credit card, and an electronic money card can be used. Here, the money coupon cannot basically be used at the self-register G2 such as from the viewpoint of fraud prevention or the like. Therefore, in the embodiment, the self-accounting machine 50 does not receive payment by a money coupon. The payment by a money coupon is received by the manned accounting machine 40 of the encounter register G1 at which the salesclerk M2 always stays. Therefore, when the salesclerk M2 scans an accounting barcode with the scanner SC1 even in the manned accounting machine 40, a purchased commodity list of the customer M1 is input to the manned accounting machine 40 and a settlement amount of one transaction is displayed. Thereafter, when money is paid through the salesclerk M2 in accordance with a payment method using a money coupon or the like, the purchased commodity is settled.

A ratio of the number of manned accounting machines 40 installed at the encounter register G1 to the number of self-accounting machines 50 installed at the self-register G2 is not particularly limited. The ratio is a factor which can be determined appropriately for each store in consideration of a tendency of shoppers, a store area, a personnel cost, and the like.

Next, the information terminal 10, the store server 20, and the virtual POS server 30 will be described in detail.

FIG. 3 is a block diagram illustrating an example of a circuit configuration of main units of the information terminal 10. The information terminal 10 includes a processor 11, a main storage device 12, an auxiliary storage device 13, a wireless unit 14, a touch panel 15, a scanner 16, a reader 17, a camera 18, and a system transmission path 19. The system transmission path 19 includes an address bus, a data bus, and a control signal line. In the information terminal 10, the processor 11, the main storage device 12, the auxiliary storage device 13, the wireless unit 14, the touch panel 15, the scanner 16, the reader 17, and the camera 18 are connected to the system transmission path 19. In the information terminal 10, a computer is configured by the processor 11, the main storage device 12, the auxiliary storage device 13, and the system transmission path 19 connecting them.

The processor 11 is equivalent to a center of the computer. The processor 11 controls each unit such that various functions as the information terminal 10 can be realized in accordance with an operating system and an application program. The processor 11 is, for example, a central processing unit (CPU).

The main storage device 12 is equivalent to a main storage of the computer. The main storage device 12 includes a nonvolatile memory area and a volatile memory area. The main storage device 12 stores some or all of the operating system and application programs in the nonvolatile memory area. The main storage device 12 stores data necessary for the processor to perform a process of controlling each unit in the nonvolatile or volatile memory area in some cases. In the main storage device 12, the volatile memory area is used as a work area in which data is appropriately rewritten by the processor 11. The nonvolatile memory area may be, for example, a read-only memory (ROM). The volatile memory area may be, for example, a random access memory (RAM).

The auxiliary storage device 13 is equivalent to an auxiliary storage of the computer. For example, the auxiliary storage device 13 is configured by one or more units among an electric erasable programmable read-only memory (EEPROM: registered trademark), a hard disc drive (HDD), and a solid-state drive (SSD). The auxiliary storage device 13 stores data to be used for the processor 11 to perform various processes, data generated through a process by the processor 11, or the like. The auxiliary storage device 13 stores the application programs in some cases.

The wireless unit 14 performs wireless communication of data in conformity with a wireless communication protocol with the access point 60.

The touch panel 15 is a device that functions as an input device and a display device of the information terminal 10. The touch panel 15 detects a touch position in a displayed image and outputs touch positional information to the processor 11.

The scanner 16 reads a code symbol such as a barcode or a 2-dimensional data code attached to a commodity. A code symbol indicating a commodity code is attached to a commodity. The scanner 16 outputs data of the read code symbol to the processor 11. The scanner 16 may be a type of scanner that reads the code symbol through scanning of laser light or may be a type of scanner that reads a code symbol from an image captured by an imaging device.

The reader 17 reads data stored in a storage medium and outputs the read data to the processor 11. The reader 17 is a magnetic card reader when the storage medium is a magnetic card, and is an IC card reader when the storage medium is a contact IC card. When a storage medium such as a contactless IC card or a smartphone that uses radio frequency identification (RFID) is used, an RFID reader is used as the reader 17.

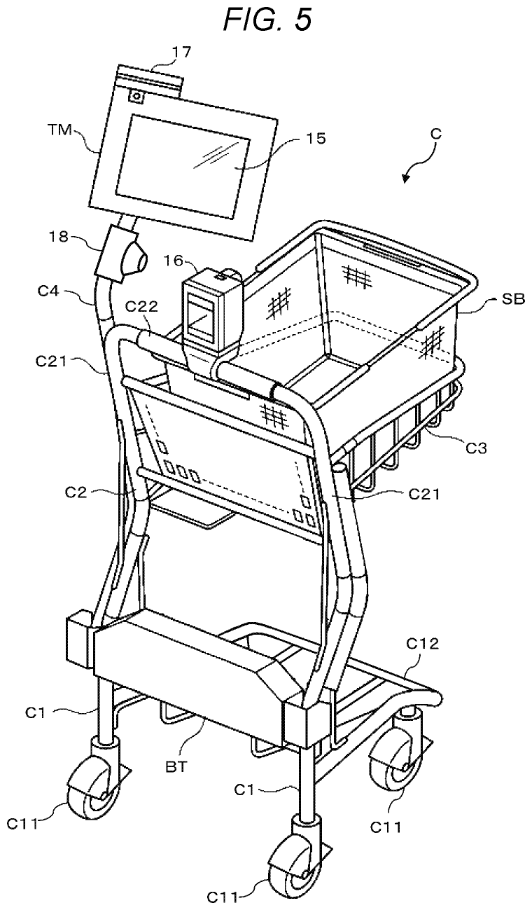

The camera 18 is provided in the cart C so that a shopping basket placed on a basket reception portion C3 (see FIG. 5) of the cart C can be imaged from the upper side. The camera 18 is used to monitor whether a customer who is a user of the cart C correctly puts a purchased commodity into the shopping basket.

In the information terminal 10 that includes the above-described circuit configuration elements, the processor 11, the main storage device 12, the auxiliary storage device 13, the wireless unit 14, and the touch panel 15 are configured as a tablet terminal TM. The information terminal 10 is configured by electrically connecting the scanner 16, the reader 17, and the camera 18 to the tablet terminal TM.

FIG. 4 is a block diagram illustrating an example of a circuit configuration of main units of the store server 20. The store server 20 includes a processor 21, a main storage device 22, an auxiliary storage device 23, a communication unit 24, an input unit 25, a display 26, and a system transmission path 27. The system transmission path 27 includes an address bus, a data bus, and a control signal line. In the store server 20, the processor 21, the main storage device 22, the auxiliary storage device 23, the communication unit 24, the input unit 25, and the display 26 are connected to the system transmission path 27. In the store server 20, a computer is configured by the processor 21, the main storage device 22, the auxiliary storage device 23, and the system transmission path 27 connecting them.

The processor 21 is equivalent to a center of the computer. The processor 21 controls each unit such that various functions as the store server 20 can be realized in accordance with an operating system and an application program. The processor 21 is, for example, a CPU.

The main storage device 22 is equivalent to a main storage of the computer. The main storage device 22 includes a nonvolatile memory area and a volatile memory area. The main storage device 22 stores some or all of the operating system and application programs in the nonvolatile memory area. The main storage device 22 stores data necessary for the processor to perform a process of controlling each unit in the nonvolatile or the volatile memory area in some cases. In the main storage device 22, the volatile memory area is used as a work area in which data is appropriately rewritten by the processor 21. The nonvolatile memory area is, for example, a ROM. The volatile memory area is, for example, a RAM.

The auxiliary storage device 23 is equivalent to an auxiliary storage of the computer. For example, the auxiliary storage device 23 is configured by one or more units among an EEPROM, an HDD, and an SSD. The auxiliary storage device 23 stores data to be used for the processor 21 to perform various processes, data generated through a process by the processor 21, or the like. The auxiliary storage device 23 stores the application programs in some cases.

The application programs stored in the main storage device 22 or the auxiliary storage device 23 include a control program that describes information processing performed in the store server 20. A method of installing the control program in the main storage device 22 or the auxiliary storage device 23 is not particularly limited. By recording the control program on a removable storage medium or delivering the control program through communication via a network, the control program can be installed in the main storage device 22 or the auxiliary storage device 23. Any type of storage medium can be used as long as the storage medium is a non-transitory computer-readable storage medium capable of storing a program and allowing a device to read a program, such as a CD-ROM or a memory card.

The communication unit 24 performs wireless communication of data in conformity with a wireless communication protocol with the access point 60. The communication unit 24 performs data communication in conformity with a communication protocol with another device connected via the network 80.

The input unit 25 receives an input of various kinds of information from an operator.

The display 26 is a display unit that displays various kinds of information.

FIG. 5 is a perspective view illustrating an example of the cart C in which the information terminal 10 is provided. The cart C includes a caster portion C1 for movement, a handle frame portion C2, and the basket reception portion C3. The caster portion C1 has four wheels C11 for smooth movement on the surface of a floor. The caster portion C1 has a reception portion C12 on which large luggage which does not enter a shopping basket SB is put. The handle frame portion C2 includes a pair of vertical frames C21 and C21 erected on the rear wheels of the caster portion C1 and a handle bar C22 connecting the upper ends of the vertical frames C21 and C21. The basket reception portion C3 is located forward from a midway portion of the handle frame C2. In the cart C, the shopping basket SB provided in a store can be placed on the basket reception portion C3. The shopping basket SB is used to accommodate commodities.

The scanner 16 is in the midway portion of the handle bar C22. The scanner 16 is attached to the handle bar C22 so that a reading window is located on a near side. The near side is a side where a customer pushing the cart C with the handle bar C22 stands.

A pole C4 is attached to one vertical frame C21. A tip of the pole C4 is located above the handle bar C22. The tablet terminal TM is attached at the tip portion of the pole C4 so that the screen of the touch panel 15 faces the front. The reader 17 is attached to the tablet terminal TM so that a card slot is located on the near side. In FIG. 5, the reader 17 is a magnetic card reader. The camera 18 is attached to the midway portion of the pole C4 so that the entire shopping basket SB placed on the basket reception portion C3 is imaged from the upper side.

A battery BT is attached across the vertical frames C21 and C21 on the lower end side of the handle frame C2. The battery BT serves as a driving power supply of the tablet terminal TM, the scanner 16, the reader 17, and the camera 18.

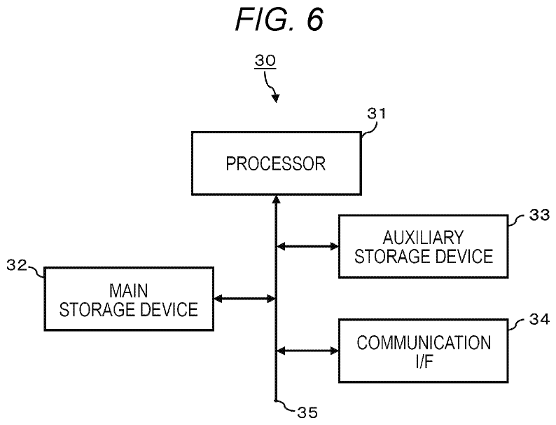

FIG. 6 is a block diagram illustrating an example of a circuit configuration of main units of the virtual POS server 30. The virtual POS server 30 includes a processor 31, a main storage device 32, an auxiliary storage device 33, a communication interface 34, and a system transmission path 35. The system transmission path 35 includes an address bus, a data bus, and a control signal line. In the virtual POS server 30, the processor 31, the main storage device 32, the auxiliary storage device 33, and the communication interface 34 are connected to the system transmission path 35. In the virtual POS server 30, a computer is configured by the processor 31, the main storage device 32, the auxiliary storage device 33, and the system transmission path 35 connecting them.

The processor 31 is equivalent to a center of the computer. The processor 31 controls each unit such that various functions as the virtual POS server 30 can be realized in accordance with an operating system and an application program. The processor 31 is, for example, a CPU.

The main storage device 32 is equivalent to a main storage of the computer. The main storage device 32 includes a nonvolatile memory area and a volatile memory area. The main storage device 32 stores some or all of the operating system and application programs in the nonvolatile memory area. The main storage device 32 stores data necessary for the processor to perform a process of controlling each unit in the nonvolatile or the volatile memory area in some cases. In the main storage device 32, the volatile memory area is used as a work area in which data is appropriately rewritten by the processor 31. The nonvolatile memory area is, for example, a ROM. The volatile memory area is, for example, a RAM.

The auxiliary storage device 33 is equivalent to an auxiliary storage of the computer. For example, the auxiliary storage device 33 is configured by one or more units among an EEPROM, an HDD, and an SSD. The auxiliary storage device 33 stores data to be used for the processor 31 to perform various processes, data generated through a process by the processor 31, or the like. The auxiliary storage device 33 stores the application programs in some cases.

The application programs stored in the main storage device 32 or the auxiliary storage device 33 include a control program that describes information processing performed in the virtual POS server 30. A method of installing the control program in the main storage device 32 or the auxiliary storage device 33 is not particularly limited. By recording the control program on a removable storage medium or delivering the control program through communication via a network, the control program can be installed in the main storage device 32 or the auxiliary storage device 33. Any type of storage medium can be used as long as the storage medium is a non-transitory computer-readable storage medium capable of storing a program and allowing a device to read a program, such as a CD-ROM or a memory card.

The communication interface 34 is connected to the network 80. The communication interface 34 performs data communication in conformity with a communication protocol with another device connected via the network 80.

Next, area transition prediction by the store server 20 will be described.

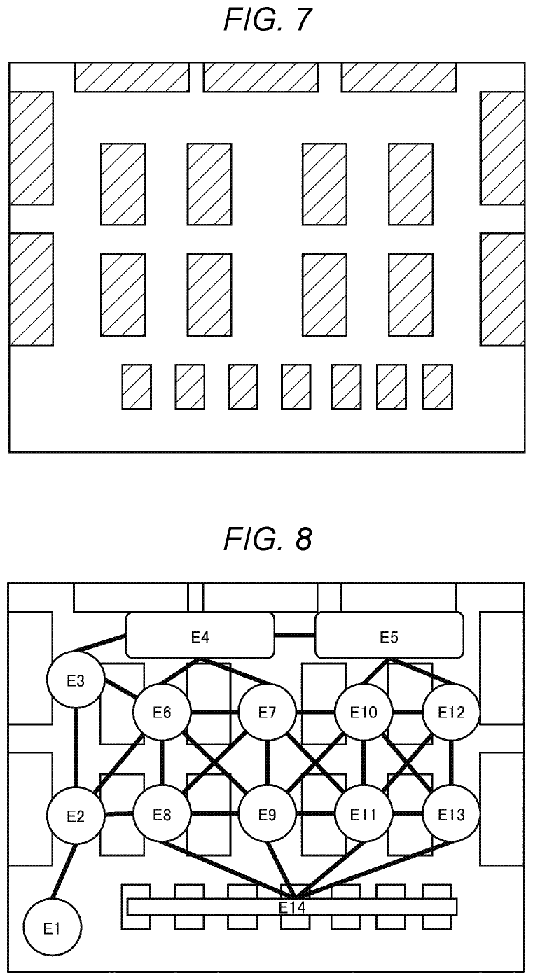

FIG. 7 is a diagram illustrating an example of a layout of each sales area in a store. As illustrated in FIG. 7, in each sales area, shelves (shaded portions) on which commodities are exhibited are arranged and a passage for a customer is formed between shelves.

FIG. 8 is an example of map information corresponding to the layout of FIG. 7. The auxiliary storage device 23 of the store server 20 stores map information. The map information includes a plurality of areas facing shelves on which commodities are exhibited and further includes an area for accounting. Area identifications (IDs) (E1 to E13) are allocated to the plurality of areas facing the shelves on which commodities are exhibited and an ID (E14) is allocated to the area for accounting. Customers staying in the areas E1 to E13 can see or pick up commodities exhibited at facing positions. In other words, it is predicted that the customers staying in the areas E1 to E13 are attracted to and interested in the commodities exhibited at the facing positions.

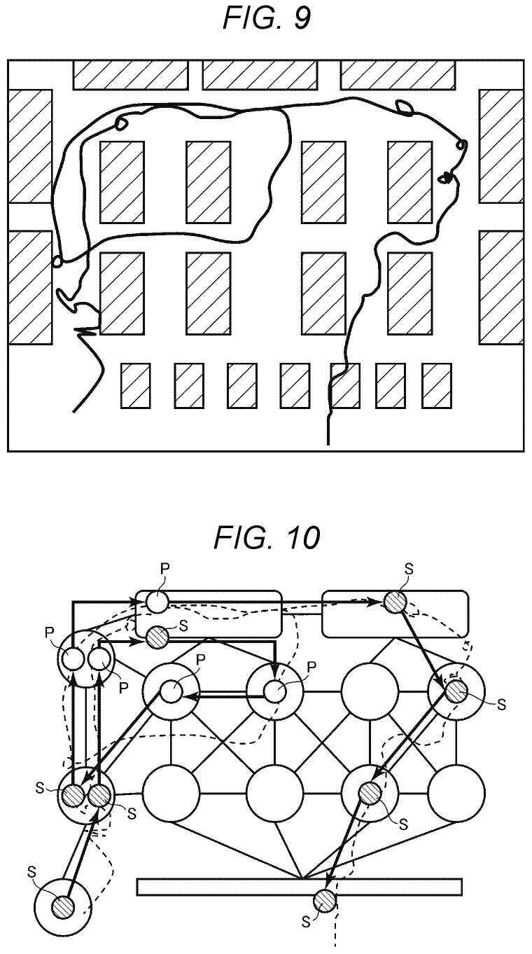

FIG. 9 is a diagram illustrating an example of a traffic line of a customer superimposed on the layout of FIG. 7 or the map of FIG. 8. The camera 70 performs imaging in the store and transmits captured images including imaging dates to the store server 20. For example, the imaging dates are date data expressed by years, months, days, hours, minutes, and seconds. The communication unit 24 of the store server 20 receives the captured images from the camera 70 and the processor 21 registers the captured images in an image database of the auxiliary storage device 13.

The processor 21 analyzes facial images or the like included in the captured images registered in the image database, detects positions of the customers, and generates and acquires behavior history information including positional information of the customers and date (time data) information (imaging dates) corresponding to the positional information. The processor 21 determines different customers, detects positions of the respective customers, and generates and acquires behavior history information including positional information of the respective customers and date information corresponding to the positional information. A computer different from the store server 20 may generate a behavior history. This computer may transmit the behavior history to the store server 20 and the communication unit 24 of the store server 20 may receive and acquire the behavior history. In this way, at least one of the processor 21 and the communication unit 24 functions as an acquisition unit that acquires the behavior history information.

Here, behavior analysis for a customer based on the behavior history information will be described. For example, the processor 21 of the store server 20 detects a traffic line or the like of each customer based on the behavior history information including the map information including the plurality of areas E1 to E14, the positional information regarding each customer, and the date information corresponding to the positional information. Further, when a specific customer passes through the area E2, the processor 21 analyzes the area E2 as a passage area of the specific customer based on the map information and the behavior history information. When the specific customer stays in the area E3, the processor 21 analyzes the area E3 as a stay area of the specific customer. For example, the processor 21 analyzes an area in which a customer stays continuously for 5 seconds or longer as a stay area and analyzes an area in which a customer enters but does not stay continuously for 5 seconds or longer as a passage area.

Further, the processor 21 can specify a customer based on customer registration data registered in advance. For example, the auxiliary storage device 13 stores the customer registration data registered in advance. The customer registration data includes a facial image of a registered customer (a registered user) and customer identification information (hereinafter, referred to as a customer ID) corresponding to the facial image. The processor 21 detects a customer ID corresponding to a customer from a facial image of the customer included in a captured image based on the customer registration data. In this way, the processor 21 can analyze a behavior of a specified customer.

A smart device carried by a customer or the information terminal 10 attached to the shopping cart C may be used to detect a position of the smart device or the information terminal 10 as a position of the customer, behavior history information may be generated and acquired, and a behavior of the customer may be analyzed. For example, the smart device or the information terminal 10 (hereinafter, referred to as a smart device or the like) may store a membership application and a positioning application and executes these applications. The customer inputs a customer ID and a password registered in advance to a membership application of a smart device or the like. The smart device or the like communicates with the store server 20 or the like via the access point 60 or the like to log in based on the customer ID and the password. Further, the smart device or the like communicates with one or more beacon devices connected to the network 80 by executing the positioning application, and measures a position of the smart device or the like to acquire positional information based on the positional information of the beacon device and a radio wave strength from the beacon device. The smart device or the like transmits the acquired positional information to the store server 20. The store server 20 detects positional information of the smart device or the like as positional information of the customer in association with the customer ID and acquires the behavior history information including the positional information of the customer and date information corresponding to the positional information.

FIG. 10 is a diagram illustrating an example of behavior analysis of a specific customer by the store server 20. The processor 21 of the store server 20 analyzes a passage (P) and a stay (S) of the specific customer in each area based on the map information and the behavior history information.

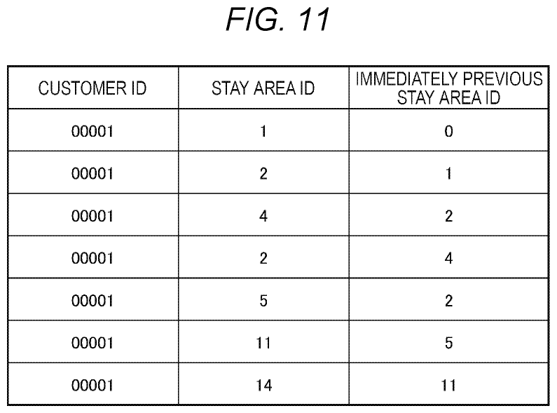

FIG. 11 is a diagram illustrating an example of a first stay area analysis database managed by the store server 20. The processor 21 of the store server 20 generates a first stay area analysis database including a plurality of records based on the map information, the behavior history information, and the customer registration data. One record includes a customer ID, a stay area ID, and an immediately previous stay area ID. According to the first stay area analysis database, a trace of a customer can be followed.

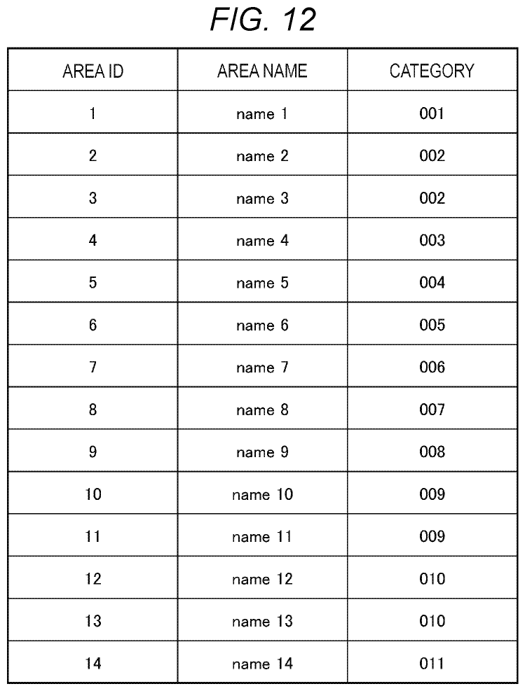

FIG. 12 is a diagram illustrating an example of an area management database registered in the store server 20. The area management database includes a plurality of records, and each record includes an area ID, an area name, and a category. For example, the area name is an entrance, fruits and vegetables, fish, meat, confectionery, or the like. A category is an entrance, fruits and vegetables, fish, meat, confectionery, or the like.

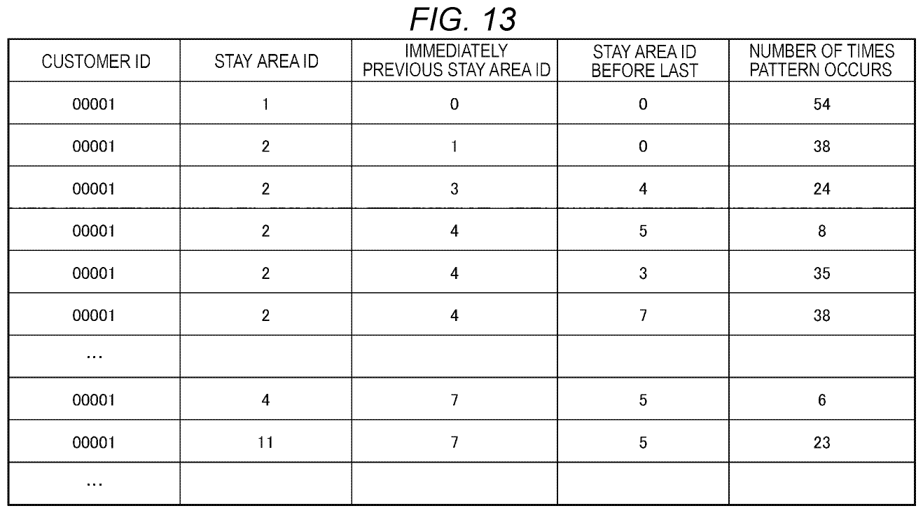

FIG. 13 is a diagram illustrating an example of a second stay area analysis database managed by the store server 20. The processor 21 of the store server 20 generates the second stay area analysis database including a plurality of records based on the map information, the behavior history information, and the customer registration data. One record includes a customer ID, a stay area ID, an immediately previous stay area ID, a stay area ID before the last stay area, and the number of times a pattern occurs, for example. According to the second stay area analysis database, a tendency of a behavior pattern of the customer can be analyzed.

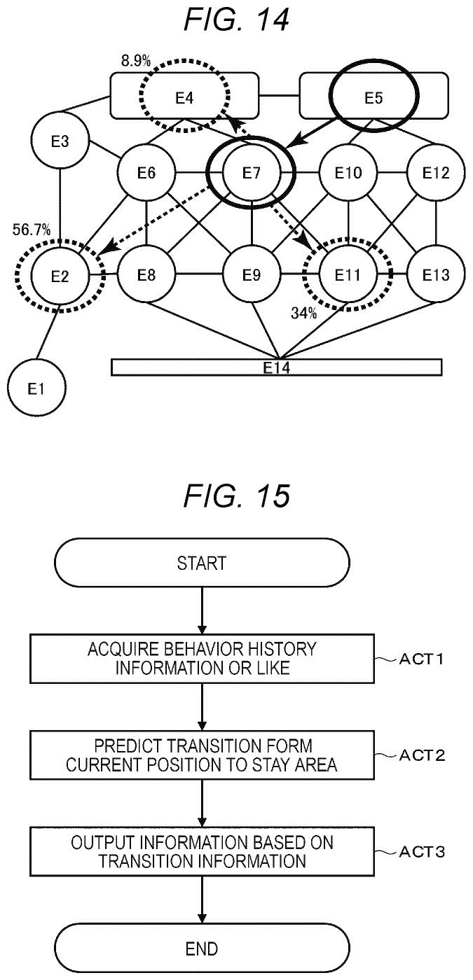

FIG. 14 is a diagram illustrating an example of a transition probability of a stay area by the store server 20. The processor 21 of the store server 20 functions as an information processing unit that predicts transition from a current stay area which is a current position of a customer to a subsequent stay area based on the map information, the behavior history information, and the customer registration data. For example, the processor 21 predicts the transition of the stay area for each customer ID. As illustrated in FIG. 14, after transition from the stay area E5 to the stay area E7, the processor 21 predicts a transition probability from the stay area E7 (a current stay area) to the stay area E2 (a subsequent stay area) to be 56.7%, predicts a transition probability from the stay area E7 (the current stay area) to the stay area Ell (a subsequent stay area) to be 34%, predicts a transition probability from the stay area E7 (a current stay area) to the stay area E4 (a subsequent stay area) to be 8.9%, generates a stay area prediction database, and registers the stay area prediction database in the auxiliary storage device 23. That is, the stay area transition prediction database includes a stay area transition prediction for each customer.

The processor 21 predicts transition from the current stay area which is a current position of a certain customer to a subsequent stay area based on the stay area prediction database. For example, the processor 21 calculates a transition probability from the current stay position which is a current position of a statistically general customer to a subsequent stay area based on the prediction of transition to the stay area for each customer and predicts transition to the subsequent stay area of the certain customer.

Alternatively, when a customer in the store can be specified based on the customer registration data, the processor 21 predicts transition to a subsequent stay area of the specific customer based on the transition prediction of the stay area of the specific customer included in the stay area prediction database. In this way, by using the transition prediction of the stay area of the specific customer, it is possible to improve prediction precision.

The processor 21 generates information indicating the transition prediction or information based on the transition prediction, the communication unit 24 transmits the information indicating the transition prediction or the information based on the transition prediction, and the communication unit functions as an output unit that outputs the information. Alternatively, the display 26 displays the information indicating the transition prediction or the information based on the transition prediction. The display 26 functions as an output unit that outputs the information.

FIG. 15 is a flowchart illustrating an example of transition prediction and information output of the stay area by the store server 20. The processor 21 acquires the behavior history information by generating the behavior history information including the positional information of the customer and the date information corresponding to the positional information (ACTT). Alternatively, the communication unit 24 acquires the behavior history information by receiving behavior history information generated by another computer (ACTT).

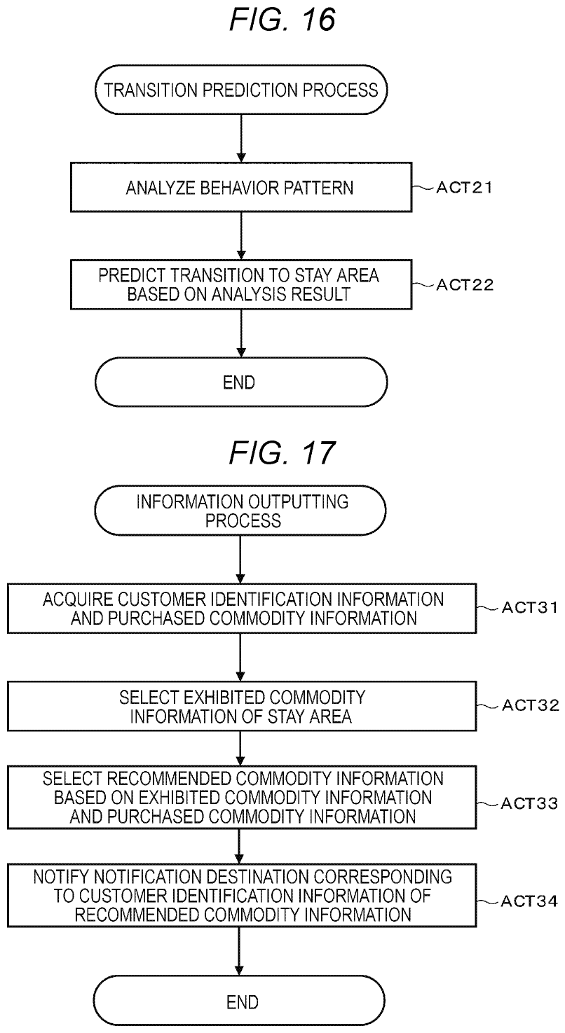

The processor 21 predicts transition from a current stay area which is a current position of the customer to a subsequent stay area based on the behavior history information and the map information including a plurality of areas (ACT2). A transition prediction process of ACT2 will be described in detail with reference to the flowchart illustrated in FIG. 16.

The communication unit 24 outputs information based on the transition prediction (ACT3). The processor 21 selects exhibited commodity information of the stay area of a predicted transition destination and the communication unit 24 outputs the selected exhibited commodity information. For example, the auxiliary storage device 23 of the store server 20 stores the commodity database. The commodity database is a collective of commodity records. In the commodity record, commodity information such as a commodity code, a price, a commodity name, exhibition area information, and recommended commodity information is described. The exhibition area information includes an area ID and the recommended commodity information includes a commodity code of a recommended commodity. For example, according to the recommended commodity information, pasta sauces for pasta can be recommended, or meats or vegetables for curry roux can be recommended. Alternatively, the recommended commodity information may include information regarding a first recommendation level, a second recommendation level, a third recommendation level, or non-recommendation. The first recommendation level is set as the highest recommendation level, the second recommendation level is set as the second-highest recommendation level, and the third recommendation level is set as the third-highest recommendation level. The processor 21 selects information such as commodity names exhibited in a stay area of a predicted transition destination based on the commodity record and the communication unit 24 outputs the selected information such as the commodity names. An information outputting process of ACT3 will be described in detail with reference to the flowchart illustrated in FIG. 17.

FIG. 16 is a flowchart illustrating an example of a transition prediction process by the store server 20. The processor 21 analyzes a behavior pattern of a customer based on the map information, the behavior history information, and the customer registration data (ACT21). The processor 21 analyzes what kind of commodity is displayed in an area where the customer stays and then what kind of commodity is displayed in a subsequent area where the customer stays, and predicts transition to the stay area based on an analysis result with reference to the area management database or the like (ACT22).

FIG. 17 is a flowchart illustrating an example of an information outputting process by the store server 20. For example, the communication unit 24 of the store server 20 communicates with the information terminal 10 via the access point 60 to acquire customer identification information and purchased commodity information input to the information terminal 10 (ACT31). The processor 21 selects commodity information (exhibited commodity information) exhibited in the stay area in which transition is predicted based on the commodity database (ACT32). The processor 21 selects the recommended commodity information based on the exhibited commodity information and the purchased commodity information (ACT33). For example, the processor 21 selects a purchased commodity designated as a recommended commodity among the exhibited commodities based on the commodity database.

The processor 21 notifies a notification destination corresponding to the customer identification information of the commodity recommendation information (for example, a commodity name) (ACT34). For example, the processor 21 recognizes the information terminal 10 transmitting the customer identification information as the notification destination corresponding to the customer identification information and the communication unit 24 transmits the commodity recommendation information to the information terminal 10. The wireless unit 14 of the information terminal 10 receives the recommended commodity information and the touch panel 15 displays the recommended commodity information. Alternatively, the communication unit 24 transmits the commodity recommendation information to the display device provided in the current stay area of the customer among display devices provided to correspond to the respective areas.

Alternatively, the processor 21 may select the exhibited commodity information in which the first recommendation level is set among the pieces of exhibited commodity information of the stay areas in which transition is predicted, and the communication unit 24 may transmit the selected exhibited commodity information.

Alternatively, the processor 21 may predict transition probabilities of a plurality of stay areas in which transition is predicted and select the exhibited commodity information of each stay area in accordance with the transition probability of each stay area, and the communication unit 24 may transmit the exhibited commodity information of each of the selected stay areas. For example, the processor 21 selects the pieces of exhibited commodity information in which the first, second, and third recommendation levels are set among the pieces of exhibited commodity information of the stay areas in which the transition is predicated at a highest probability. The processor 21 selects the pieces of exhibited commodity information in which the first and second recommendation levels are set among the pieces of exhibited commodity information of the stay areas in which the transition is predicated at a second-highest probability. The processor 21 selects the exhibited commodity information in which the first recommendation level is set among the pieces of exhibited commodity information of the stay areas in which the transition is predicated at a third-highest probability.

According to at least one embodiment, it is possible to provide an area transition prediction device and an area transition prediction program which are excellent in prediction precision of a purposive behavior of a customer is high. By defining a plurality of areas in accordance with the map information, determining whether a customer passes or stays in the areas, and analyzing a behavior of the customer while paying attention to a stay area, it is possible to predict the purposeful behavior of the customer with high precision. Thus, it is possible to predict transition to a subsequent stay area with high precision, suggest an effective commodity guide, and predict congestion. For example, the area E14 illustrated in FIG. 14 is the accounting area, but it is possible to predict congestion of the accounting area.

By notifying the exhibited commodity information exhibited in a subsequent stay area in advance, it is possible to expect a sales promotion effect of commodities. Further, by predicting probabilities of transition to a plurality of stay areas and outputting the exhibited commodity information of each stay area in accordance with the probability of the transition to each stay area, it is possible to provide information in accordance with the transition probability. For example, by increasing guides of commodities exhibited in the stay areas with high transition probabilities and decreasing guides of commodities exhibited in the stay areas with low transition probabilities, it is possible to guide the commodities efficiently. Alternatively, by making guides of commodities exhibited in the stay areas with high transition probabilities larger and making guides of commodities exhibited in the stay areas with low transition probabilities smaller, it is possible to guide the commodities efficiently.

By specifying a customer in accordance with the customer identification information, it is possible to raise the prediction precision. In addition, by notifying recommended commodities based on the purchased commodity information corresponding to the customer identification information, it is possible to expect a further sales promotion effect.

While certain embodiments have been described, these embodiments have been presented by way of example only, and are not intended to limit the scope of the embodiments of the inventions. Indeed, the novel embodiments described herein may be embodied in a variety of other forms; furthermore, various omissions, substitutions and changes in the form of the embodiments described herein may be made without departing from the spirit of the embodiments of the inventions. The accompanying claims and their equivalents are intended to cover such forms or modifications as would fall within the scope and spirit of the embodiments of the inventions.

What is claimed is:

1. An area transition prediction device comprising:
at least one processor configured to:
acquire behavior history information, the behavior history information including positional information of a user and date information corresponding to the positional information; and
predict transition from a current position to a first area of the user based on the behavior history information and map information, the map information including a plurality of areas; and
an output unit configured to output information based on the prediction of the transition.

2. The device according to claim 1, where the first area is a stay area where the user pauses for a predetermined length of time.

3. The device according to claim 2,
wherein the at least one processor is configured to select exhibited commodity information of the stay area, and
wherein the output unit is configured to output the exhibited commodity information.

4. The device according to claim 3,
wherein the at least one processor is configured to predict a probability of transition to a plurality of stay areas and to select exhibited commodity information of each stay area in accordance with the probability of transition to each stay area, and
wherein the output unit is configured to output the exhibited commodity information of each stay area.

5. The device according to claim 2,
wherein the at least one processor is configured to acquire user identification information,
and to predict transition from a current position to a stay area of a registered user corresponding to the user identification information, and
wherein the output unit is configured to notify a notification destination corresponding to the user identification information of information based on the prediction of the transition.

6. The device according to claim 2,
wherein the at least one processor is configured to acquire user identification information and purchased commodity information, and
to select recommended commodity information based on the purchased commodity information and exhibited commodity information of the stay area, and
wherein the output unit is configured to notify a notification destination corresponding to the user identification information of the recommended commodity information.

7. The device according to claim 6, wherein the at least one processor is configured to select recommended commodity information based on recommendation levels of the purchased commodity information.

8. A computer implemented area transition prediction method, comprising:
acquiring behavior history information, the behavior history information including positional information of a user and date information corresponding to the positional information;
predicting transition from a current position to a first area of the user based on the behavior history information and map information, the map information including a plurality of areas; and
outputting information based on the prediction of the transition.

9. The computer implemented method according to claim 8, where the first area is a stay area where the user pauses for a predetermined length of time.

10. The computer implemented method according to claim 9, further comprising:
selecting exhibited commodity information of the stay area; and
outputting the exhibited commodity information.

11. The computer implemented method according to claim 10, further comprising:
predicting a probability of transition to a plurality of stay areas and selecting exhibited commodity information of each stay area in accordance with the probability of transition to each stay area; and
outputting the exhibited commodity information of each stay area.

12. The computer implemented method according to claim 9, further comprising:
acquiring user identification information;
predicting transition from a current position to a stay area of a registered user corresponding to the user identification information; and
notifying a notification destination corresponding to the user identification information of information based on the prediction of the transition.

13. The computer implemented method according to claim 9, further comprising:
acquiring user identification information and purchased commodity information;
selecting recommended commodity information based on the purchased commodity information and exhibited commodity information of the stay area; and
wherein the output unit is configured to notify a notification destination corresponding to the user identification information of the recommended commodity information.

14. The computer implemented method according to claim 13, wherein the selecting recommended commodity information includes selecting recommended commodity information based on recommendation levels of the purchased commodity information.

15. A non-transitory computer readable storage medium storing computer instructions, wherein when executed by a computer, the instructions perform an area transition prediction method, the method comprising:
acquiring behavior history information, the behavior history information including positional information of a user and date information corresponding to the positional information;
predicting transition from a current position to a stay area of the user based on the behavior history information and map information, the map information including a plurality of areas; and
outputting information based on the prediction of the transition.

16. The computer readable storage medium according to claim 15, the method further comprising:
selecting exhibited commodity information of the stay area; and
outputting the exhibited commodity information.

17. The computer readable storage medium according to claim 16, the method further comprising:
predicting a probability of transition to a plurality of stay areas and selecting exhibited commodity information of each stay area in accordance with the probability of transition to each stay area; and
outputting the exhibited commodity information of each stay area.

18. The computer readable storage medium according to claim 15, the method further comprising:
acquiring user identification information;
predicting transition from a current position to a stay area of a registered user corresponding to the user identification information; and
notifying a notification destination corresponding to the user identification information of information based on the prediction of the transition.

19. The computer readable storage medium according to claim 15, the method further comprising:
acquiring user identification information and purchased commodity information;
selecting recommended commodity information based on the purchased commodity information and exhibited commodity information of the stay area; and
wherein the output unit is configured to notify a notification destination corresponding to the user identification information of the recommended commodity information.

20. The computer readable storage medium according to claim 15, wherein the selecting recommended commodity information includes selecting recommended commodity information based on recommendation levels of the purchased commodity information.
